(19) United States
(12) Patent Application Publication
(10) Pub. No.: US 2014/0218415 A1
(43) Pub. Date: Aug. 7, 2014

(54) PIXEL CIRCUIT OF AN ORGANIC LIGHT EMITTING DISPLAY DEVICE AND METHOD OF OPERATING THE SAME

(71) Applicant: SAMSUNG DISPLAY CO., LTD., Yongin-City (KR)

(72) Inventor: Sang-Jin Pak, Yongin-City (KR)

(73) Assignee: SAMSUNG DISPLAY CO., LTD., Yongin-City (KR)

(21) Appl. No.: 14/166,512

(22) Filed: Jan. 28, 2014

(30) Foreign Application Priority Data
Feb. 1, 2013 (KR) 10-2013-0011856

(51) Int. Cl. G09G 3/32

(52) U.S. Cl. CPC G09G 3/3291
USPC 345/690; 345/212

(57) ABSTRACT

A pixel circuit of a display device includes a capacitor having first and second electrodes, a switching transistor having a gate terminal coupled to a scan line, a first terminal coupled to a data line, and a second terminal coupled to the capacitor's first electrode, an emission control transistor having a gate terminal coupled to an emission control line, a first terminal coupled to a power supply, and a second terminal, the emission control line being coupled to the emission control transistor's gate terminal and the capacitor's second electrode, and a panel distribution compensating voltage being applied to the capacitor's second electrode through the emission control line, a driving transistor having a gate terminal coupled to the capacitor's first electrode, a first terminal coupled to the emission control transistor's second terminal, and a second terminal, and an organic light emitting diode coupled to the driving transistor.

### CROSS REFERENCE TO RELATED APPLICATION

This application claims priority to and the benefit of Korean Patent Application No. 10-2013-0011856 filed in Korea on Feb. 1, 2013, the disclosure of which is hereby incorporated by reference in its entirety.

### BACKGROUND

1. Field

Embodiments of the present invention relate to pixel circuits of organic light emitting display devices, and methods of operating the pixel circuits of the organic light emitting display devices.

2. Description of the Related Art

An active-matrix type of organic light emitting display device may be driven with an analog driving method or a digital driving method. While the analog driving method produces grayscale with a variable voltage level of data, the digital driving method produces grayscale with a variable time duration for which an organic light emitting diode emits light. The analog driving method has a difficulty in manufacturing a driving integrated circuit (IC) with a large size and high resolution of a panel; however, the digital driving method may readily realize the high resolution through a simpler IC structure. Also, the digital driving method uses on and off states of a driving thin film transistor (TFT) that is seldom influenced by image quality deterioration due to a TFT characteristic deviation. Therefore, digital driving methods are useful for a large panel.

However, in the digital driving method, a data voltage is applied to the data line with a high speed, and thereby, power consumption for charging and discharging the data line is increased compared with the analog driving method. Further, even if display panels are manufactured by the same process, a threshold voltage deviation between TFTs of the display panels may occur. When compensating for the threshold voltage deviation between the display panels and the threshold voltage deviation within the same display panel by changing a level of the data voltage, a range of the data voltage applied to the data line may be increased. Accordingly, the power consumption for charging and discharging the data line may further be increased.

### SUMMARY

Example embodiments provide a pixel circuit of an organic light emitting display device capable of reducing power consumption for charging and discharging a data line.

Example embodiments provide a method of operating a pixel circuit of an organic light emitting display device capable of reducing power consumption for charging and discharging a data line.

According to one aspect of the present invention, there is provided a pixel circuit of an organic light emitting display device including: a storage capacitor including a first electrode and a second electrode; a switching transistor having a gate terminal coupled to a scan line, a first terminal coupled to a data line, and a second terminal coupled to the first electrode of the storage capacitor; an emission control transistor having a gate terminal coupled to an emission control line, a first terminal coupled to a first power supply voltage, and a second terminal; a driving transistor having a gate terminal coupled to the first electrode of the storage capacitor, a first terminal coupled to the second terminal of the emission control transistor, and a second terminal; and an organic light emitting diode including an anode electrode coupled to the second terminal of the driving transistor, and a cathode electrode coupled to a second power supply voltage. Here, the emission control line is coupled to the gate terminal of the emission control transistor and is coupled to the second electrode of the storage capacitor, and a panel distribution compensating voltage is configured to be applied to the second electrode of the storage capacitor through the emission control line.

The switching transistor may be configured to apply one of an emission data voltage or a non-emission data voltage received from the data line to the first electrode of the storage capacitor in response to a scan signal received from the scan line.

The emission data voltage and the non-emission data voltage may have opposite electrical polarities from each other.

The emission data voltage may be a negative voltage, and the non-emission data voltage may be a positive voltage.

The emission data voltage may include a pixel circuit distribution compensating voltage.

A threshold voltage deviation between a plurality of display panels may be configured to be compensated by the panel distribution compensating voltage applied through the emission control line, and a threshold voltage deviation between a plurality of pixel circuits in a single display panel may be configured to be compensated by the pixel circuit distribution compensating voltage applied through the data line.

The emission control transistor may be configured to receive, as an emission control signal, the panel distribution compensating voltage from the emission control line.

The emission control transistor may be configured to couple the first power supply voltage to the first terminal of the driving transistor in response to the panel distribution compensating voltage received from the emission control line.

The pixel circuit may further include: a monitoring transistor having a gate terminal coupled to a monitoring line, a first terminal coupled to the data line, and a second terminal coupled to the first terminal of the driving transistor.

The monitoring transistor may be configured to couple the data line to the first terminal of the driving transistor in response to a monitoring signal received from the monitoring line.

The panel distribution compensating voltage may be determined by measuring a current flowing through a path including the data line, the monitoring transistor, the driving transistor, and the organic light emitting diode.

According to an aspect of the present invention, there is provided a pixel circuit of an organic light emitting display device including: a storage capacitor including a first electrode and a second electrode; a switching transistor configured to apply one of an emission data voltage or a non-emission data voltage received from a data line to the first electrode of the storage capacitor in response to a scan signal; an emission control transistor configured to be turned on in response to a panel distribution compensating voltage applied as an emission control signal through an emission control line; a driving transistor configured to generate a driving current based on a voltage of the first electrode of the storage capacitor; and an organic light emitting diode configured to emit light in response to the driving current generated by the driving transistor. Here, the emission control line is coupled to the emission control transistor and is coupled to the second electrode of the storage capacitor, and the panel distribution compensating voltage is applied to the second electrode of the storage capacitor through the emission control line.

The emission data voltage and the non-emission data voltage may have opposite electrical polarities from each other.

The emission data voltage may be a negative voltage, and the non-emission data voltage may be a positive voltage.

The emission data voltage may include a pixel circuit distribution compensating voltage.

A threshold voltage deviation between a plurality of display panels may be configured to be compensated by the panel distribution compensating voltage applied through the emission control line, and wherein a threshold voltage deviation between a plurality of pixel circuits in a single display panel may be configured to be compensated by the pixel circuit distribution compensating voltage applied through the data line.

The pixel circuit may further include: a monitoring transistor configured to couple the data line to the driving transistor in response to a monitoring signal received from a monitoring line.

The panel distribution compensating voltage may be determined by measuring a current flowing through a path including the data line, the monitoring transistor, the driving transistor and the organic light emitting diode.

According to an aspect of the present invention, there is provided a method of operating a pixel circuit of an organic light emitting display device, the method including: applying one of an emission data voltage or a non-emission data voltage to a first electrode of a storage capacitor through a data line; applying a panel distribution compensating voltage as an emission control signal to an emission control transistor and to a second electrode of the storage capacitor through an emission control line; and driving an organic light emitting diode based on a voltage of the first electrode of the storage capacitor.

The emission data voltage may be a negative voltage, and the non-emission data voltage may be a positive voltage.

The emission data voltage may include a pixel circuit distribution compensating voltage.

A threshold voltage deviation between a plurality of display panels may be compensated by the panel distribution compensating voltage applied through the emission control line, and a threshold voltage deviation between a plurality of pixel circuits in a single display panel may be compensated by the pixel circuit distribution compensating voltage applied through the data line.

### BRIEF DESCRIPTION OF THE DRAWINGS

The above and other features and aspects of the present invention may be understood in detail from the following description taken in conjunction with the accompanying drawings, in which:

FIG. 1 is a circuit diagram illustrating a pixel circuit of an organic light emitting display device in accordance with example embodiments;

FIG. 2A is a diagram illustrating a threshold voltage distribution of thin film transistors (TFTs) in the same display panel;

FIG. 2B is a diagram illustrating a threshold voltage distribution of TFTs in a plurality of display panels;

FIG. 3 is a flowchart illustrating a method of operating a pixel circuit of an organic light emitting display device in accordance with example embodiments;

FIG. 4 is a timing diagram for describing an operation of a pixel circuit of an organic light emitting display device in accordance with example embodiments;

FIG. 5 is a diagram illustrating levels of voltages used in a method of operating a pixel circuit of an organic light emitting display device in accordance with example embodiments;

FIG. 6 is a diagram illustrating an example of an image frame used in a method of operating a pixel circuit of an organic light emitting display device in accordance with example embodiments;

FIG. 7 is a diagram illustrating another example of an image frame used in a method of operating a pixel circuit of an organic light emitting display device in accordance with example embodiments;

FIG. 8 is a circuit diagram illustrating a pixel circuit of an organic light emitting display device in accordance with example embodiments;

FIG. 9 is a flowchart illustrating a method of determining a panel distribution compensating voltage and a pixel circuit distribution compensating voltage in accordance with example embodiments;

FIG. 10 is a block diagram illustrating an organic light emitting display device in accordance with example embodiments; and

FIG. 11 is a block diagram illustrating an electronic system including an organic light emitting display device in accordance with example embodiments.

### DETAILED DESCRIPTION

Example embodiments are described more fully hereinafter with reference to the accompanying drawings. The present invention may, however, be embodied in many different forms and should not be construed as limited to the example embodiments set forth herein. In the drawings, the sizes and relative sizes of layers and regions may be exaggerated for clarity.

It will be understood that when an element or layer is referred to as being “on,” “connected to” or “coupled to” another element or layer, it can be directly on, connected or coupled to the other element or layer or one or more intervening elements or layers may be present. In contrast, when an element is referred to as being “directly on,” “directly connected to” or “directly coupled to” another element or layer, there are no intervening elements or layers present. Like or similar reference numerals refer to like or similar elements throughout. As used herein, the term “and/or” includes any and all combinations of one or more of the associated listed items.

It will be understood that, although the terms “first,” “second,” “third,” etc. may be used herein to describe various elements, components, regions, layers, patterns and/or sections, these elements, components, regions, layers, patterns and/or sections should not be limited by these terms. These terms are only used to distinguish one element, component, region, layer pattern or section from another region, layer, pattern or section. Thus, a first element, component, region, layer or section discussed below may be termed a second element, component, region, layer or section without departing from the teachings of example embodiments.

The terminology used herein is for the purpose of describing particular example embodiments only and is not intended to be limiting of the invention. As used herein, the singular forms “a,” “an,” and “the” are intended to include the plural forms as well, unless the context clearly indicates otherwise. It will be further understood that the terms “comprises” and/or “comprising,” when used in this specification, specify the presence of the stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this present invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

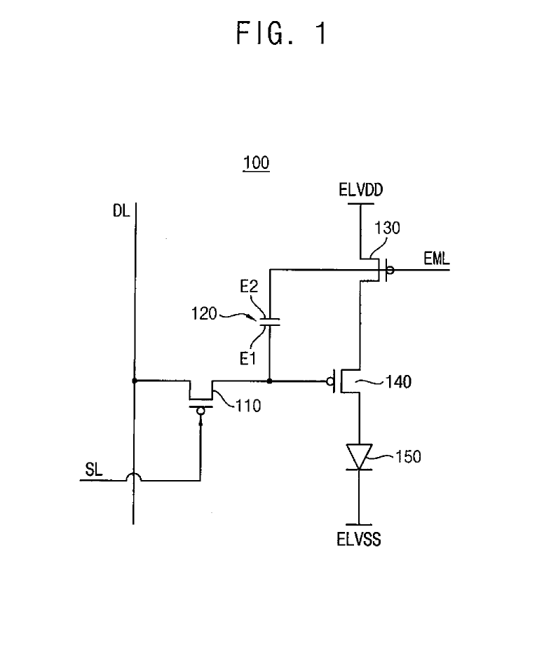

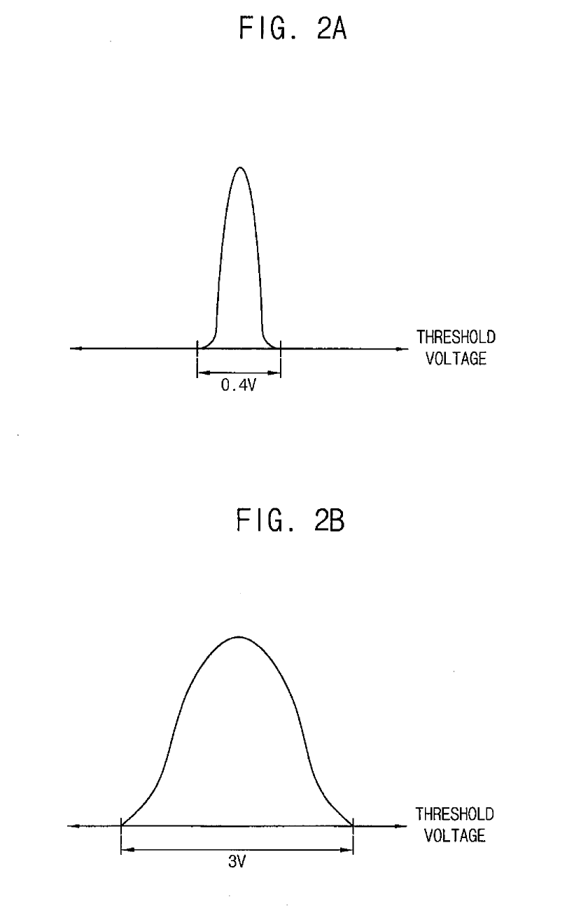

FIG. 1 is a circuit diagram illustrating a pixel circuit of an organic light emitting display device in accordance with example embodiments, FIG. 2A is a diagram illustrating a threshold voltage distribution of thin film transistors (TFTs) in the same display panel, and FIG. 2B is a diagram illustrating a threshold voltage distribution of TFTs in a plurality of display panels.

Referring to FIG. 1, a pixel circuit 100 of an organic light emitting display device includes a switching transistor 110, a storage capacitor 120, an emission control transistor 130, a driving transistor 140, and an organic light emitting diode 150.

The switching transistor 110 may have a gate terminal coupled to a scan line SL, a first terminal (e.g., a source terminal) coupled to a data line DL, and a second terminal (e.g., a drain terminal) coupled to a first electrode E1 of the storage capacitor 120. The switching transistor 110 may be turned on in response to a scan signal applied through the scan line SL. While the switching transistor 110 is turned on, the switching transistor 110 may apply one of an emission data voltage or a non-emission data voltage applied through the data line DL to the first electrode E1 of the storage capacitor 120. Here, the emission data voltage is a data voltage applied to the pixel circuit 100 through the data line DL during a sub-frame in which the organic light emitting diode 150 emits light, and the non-emission data voltage is a data voltage applied to the pixel circuit 100 through the data line DL during a sub-frame in which the organic light emitting diode 150 does not emit light.

In some example embodiments, the emission data voltage and the non-emission data voltage may have opposite electrical polarities. For example, the emission data voltage may be a negative voltage, and the non-emission data voltage may be a positive voltage. The organic light emitting display device including the pixel circuit 100 may be driven with a digital driving method. That is, a time duration for which the organic light emitting diode 150 emits light in one frame may be varied to produce grayscale by selectively applying the emission data voltage or the non-emission data voltage to the pixel circuit 100 in respective sub-frames. If the selectively applied emission and non-emission data voltages have opposite electrical polarities, a data voltage applied through the data line DL may transition through a ground voltage of 0 V, thereby reducing an absolute value of the data voltage and reducing power consumption for charging and discharging the data line DL.

In some example embodiments, the emission data voltage may include a pixel circuit distribution compensating voltage for compensating a threshold voltage deviation between a plurality of pixel circuits 100 in the same display panel. For example, as illustrated in FIG. 2A, TFTs in the same display panel may have a threshold voltage deviation of about 0.4 V (e.g., a maximum threshold voltage deviation). The organic light emitting display device including the pixel circuit 100 according to example embodiments may compensate for the threshold voltage deviation between the plurality of pixel circuits 100 in the same display panel by applying the pixel circuit distribution compensating voltage having a range of about 0.4 V (e.g., +/−0.4 V) through the data line DL. Accordingly, a plurality of organic light emitting diodes 150 of the plurality of pixel circuits 100 may be provided with substantially the same current, and thus, the plurality of organic light emitting diodes 150 may emit light with substantially the same luminance. In some example embodiments, the non-emission data voltage applied when the organic light emitting diode 150 does not emit light may not include the pixel circuit distribution compensating voltage.

The storage capacitor 120 may have the first electrode E1 coupled to the second terminal of the switching transistor 110 and a gate terminal of the driving transistor 140, and a second electrode E2 coupled to an emission control line EML. One of the emission data voltage or the non-emission data voltage may be applied to the first electrode E1 of the storage capacitor 120 through the data line DL and the switching transistor 110. Accordingly, charges corresponding to the one of the emission data voltage or the non-emission data voltage may be stored in the storage capacitor 120, and thus, a voltage of the first electrode E1 of the storage capacitor 120 may become the one of the emission data voltage and the non-emission data voltage.

A panel distribution compensating voltage for compensating a threshold voltage deviation between a plurality of display panels may be applied to the second electrode E2 of the storage capacitor 120 through the emission control line EML. For example, as illustrated in FIG. 2B, a plurality of display panels manufactured by the same process or a plurality of display panels of the same model may have a threshold voltage deviation of about 3 V (e.g., a maximum threshold deviation). The organic light emitting display device including the pixel circuit 100 according to example embodiments may compensate the threshold voltage deviation between the plurality of display panels by applying the panel distribution compensating voltage having a range of about 3 V (e.g., +/−3V) through the emission control line EML. The voltage of the first electrode E1 of the storage capacitor 120 may be changed by the panel distribution compensating voltage applied to the second electrode E2 of the storage capacitor 120, and thus, the threshold voltage deviation between the plurality of display panels may be compensated.

In a comparative example organic light emitting display device using the digital driving method, the threshold voltage deviation between the plurality of display panels as well as the threshold voltage deviation between the plurality of pixel circuits in the same display panel may be compensated by using the data voltage applied through the data line DL. Accordingly, a range of the data voltage applied through the data line is increased, and thus, a pad of a data driver for outputting the data voltage is formed using a high voltage process. Further, because the range of the data voltage is increased, power consumption for charging and discharging the data line DL is increased. However, in the organic light emitting display device including the pixel circuit 100 according to example embodiments, because the threshold voltage deviation between the plurality of display panels are compensated by using the panel distribution compensating voltage applied through the emission control line EML, the pad for outputting the data voltage may be formed using a typical process (e.g., a 5 V process), and the power consumption for charging and discharging the data line DL may be reduced.

The emission control transistor 130 may have a gate terminal coupled to the emission control line EML, a first terminal (e.g., a source terminal) coupled to a first power supply voltage ELVDD, and a second terminal (e.g., a drain terminal) coupled to a first terminal of the driving transistor 140. The emission control transistor 130 may receive the panel distribution compensating voltage as an emission control signal through the emission control line EML, and may be turned on in response to the panel distribution compensating voltage applied through the emission control line EML. Thus, the emission control transistor 130 may couple the first power supply voltage ELVDD to the first terminal of the driving transistor 140 in response to the panel distribution compensating voltage applied through the emission control line EML.

The driving transistor 140 may have the gate terminal coupled to the first electrode E1 of the storage capacitor 120, the first terminal (e.g., a source terminal) coupled to the second terminal of the emission control transistor 130, and a second terminal (e.g., a drain terminal) coupled to an anode terminal of the organic light emitting diode 150. The driving transistor 140 may generate a driving current based on the voltage of the first electrode E1 of the storage capacitor 120. During a sub-frame in which the organic light emitting diode 150 emits light, the emission data voltage (including the pixel circuit distribution compensating voltage) may be applied to the first electrode E1 of the storage capacitor 120, and the emission data voltage of the first electrode E1 of the storage capacitor 120 may be adjusted by the panel distribution compensating voltage applied to the second electrode E2 of the storage capacitor 120. Accordingly, the driving transistor 140 may provide the organic light emitting diode 150 with the driving current where the threshold voltage deviation between the plurality of pixel circuits in the same display panel and the threshold voltage deviation between the plurality of display panels are compensated.

The organic light emitting diode 150 may have the anode electrode coupled to the second terminal of the driving transistor 140, and a cathode electrode coupled to a second power supply voltage ELVSS. The organic light emitting diode 150 may emit light in response to the driving current generated by the driving transistor 140.

As described above, the organic light emitting display device including the pixel circuit 100 according to example embodiments may compensate the threshold voltage deviation between the plurality of display panels not by using the data voltage applied through the data line DL, but instead, by using the panel distribution compensating voltage applied through the emission control line EML, thereby reducing the power consumption for charging and discharging the data line DL. Further, the organic light emitting display device including the pixel circuit 100 according to example embodiments may use the negative voltage as the emission data voltage, and may use the positive voltage as the non-emission data voltage, thereby further reducing the power consumption for charging and discharging the data line DL.

Although FIG. 1 illustrates an example of the pixel circuit 100 including PMOS transistors 110, 130, and 140, in some example embodiments, the transistors 110, 130, and 140 of the pixel circuit 100 may be implemented as NMOS transistors.

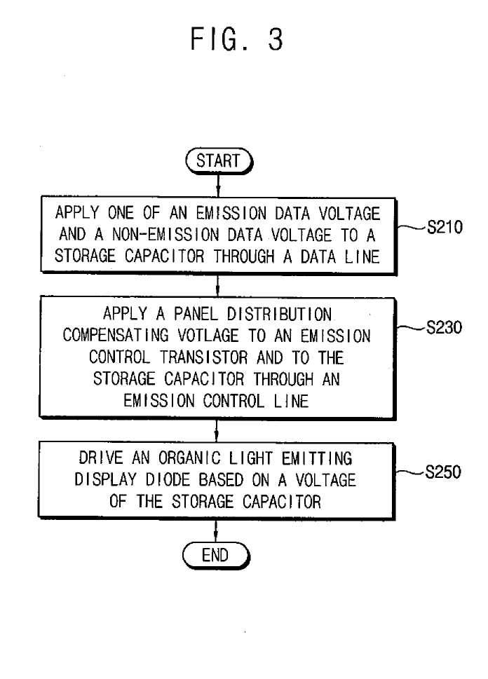

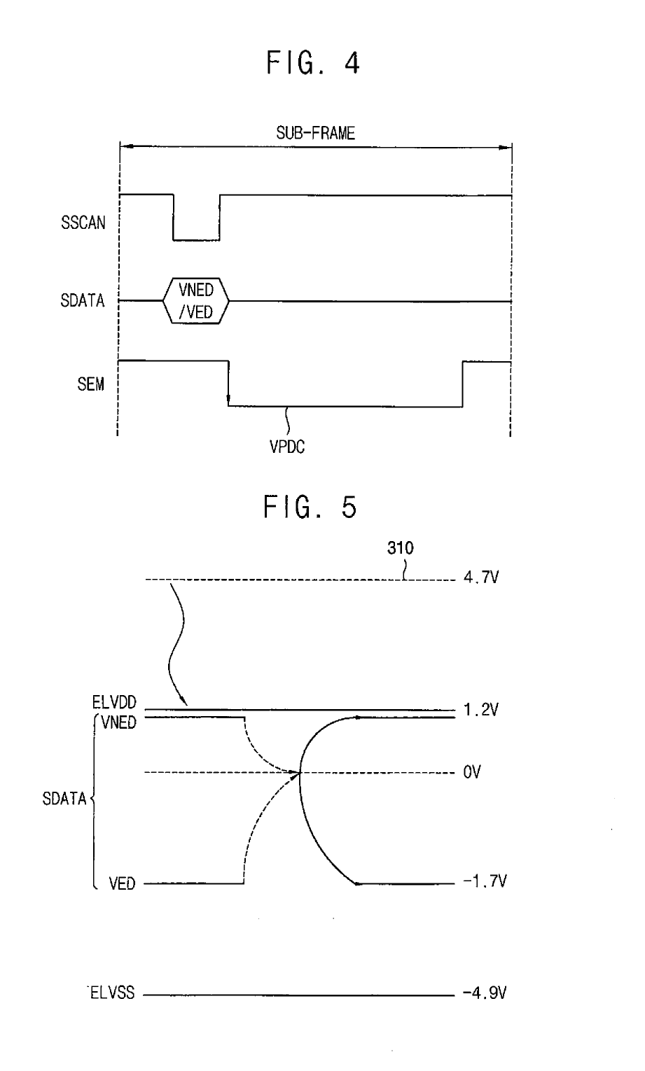

FIG. 3 is a flowchart illustrating a method of operating a pixel circuit of an organic light emitting display device in accordance with example embodiments, and FIG. 4 is a timing diagram for describing an operation of a pixel circuit of an organic light emitting display device in accordance with example embodiments.

Referring to FIGS. 1, 3, and 4, an organic light emitting display device including a pixel circuit 100 according to example embodiments may apply one of an emission data voltage VED or a non-emission data voltage VNED as a data signal SDATA to a first electrode E1 of a storage capacitor 120 through a data line DL (S210). For example, while a scan signal SSCAN applied through a scan line SL has a low level, a switching transistor 110 may be turned on. The turned-on switching transistor 110 may couple the data line DL to the first electrode E1 of the storage capacitor 120, and thus, the data signal SDATA applied through the data line DL may be applied to the first electrode E1 of the storage capacitor 120. In some example embodiments, a negative voltage may be used as the emission data voltage VED, and a positive voltage may be used as the non-emission data voltage VNED. In this case, because the data signal SDATA applied through the data line DL transitions through a ground voltage, power consumption for charging and discharging the data line DL may be reduced.

A panel distribution compensating voltage VPDC may be applied as an emission control signal SEM to an emission control transistor 130 and to a second electrode E2 of the storage capacitor 120 through an emission control line EML (S230). The emission control transistor 130 may be turned on in response to the panel distribution compensating voltage VPDC applied through the emission control line EML, and the second electrode E2 of the storage capacitor 120 may receive the panel distribution compensating voltage VPDC.

A driving transistor 140 may drive an organic light emitting diode 150 based on a voltage of the first electrode E1 of the storage capacitor 120 (S250). A pixel circuit distribution compensating voltage included in the emission data voltage VED and the panel distribution compensating voltage VPDC may be applied to the storage capacitor 120, and thus, the first electrode E1 of the storage capacitor 120 may have a voltage where a threshold voltage deviation between a plurality of pixel circuits in the same display panel and a threshold voltage deviation between a plurality of display panels are compensated. Accordingly, the organic light emitting diode 150 may be provided with a driving current where the threshold voltage deviations are compensated.

As described above, in the method of operating the pixel circuit 100 of the organic light emitting display device according to example embodiments, the threshold voltage deviation between the plurality of display panels may be compensated not by using the data signal SDATA applied through the data line DL, but instead, by using the panel distribution compensating voltage VPDC applied through the emission control line EML, thereby reducing power consumption for charging and discharging the data line DL. Further, in the method of operating the pixel circuit 100 of the organic light emitting display device according to example embodiments, a negative voltage may be used as the emission data voltage VED, and a positive voltage may be used as the non-emission data voltage VNED, thereby further reducing the power consumption for charging and discharging the data line DL

FIG. 5 is a diagram illustrating levels of voltages used in a method of operating a pixel circuit of an organic light emitting display device in accordance with example embodiments.

Referring to FIG. 5, an organic light emitting display device including a pixel circuit according to example embodiments may use, for example, a voltage of about 1.2 V as a first power supply voltage (e.g., a high power supply voltage) ELVDD, and may use, for example, a voltage of about −4.9 V as a second power supply voltage (e.g., a low power supply voltage) ELVSS. In the organic light emitting display device including the pixel circuit according to example embodiments, a threshold voltage deviation between a plurality of display panels may be compensated not by using a data voltage, but instead, by using a panel distribution compensating voltage applied through an emission control line, and thus, the data voltage may have a small range. Accordingly, the first power supply voltage ELVDD may have a voltage level lower than that of a conventional power supply voltage 310.

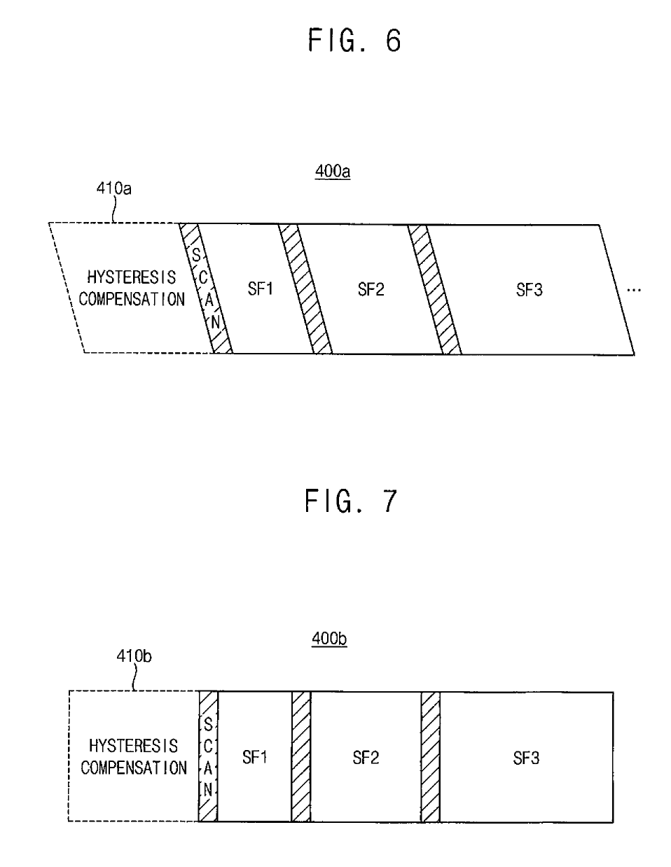

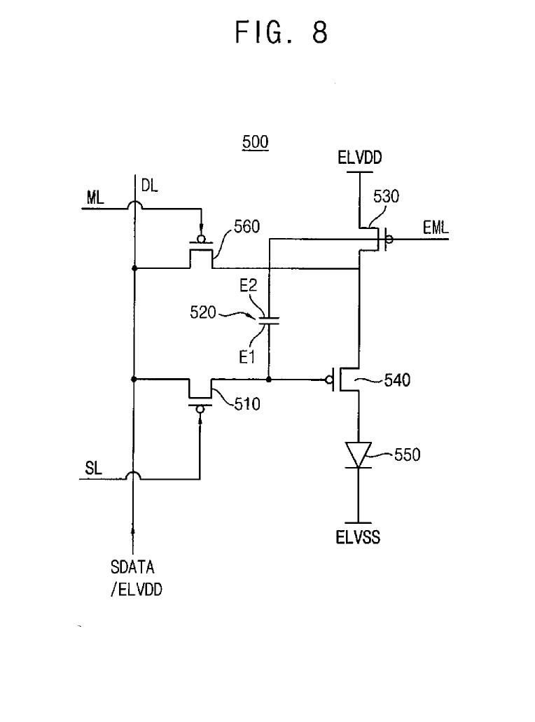

FIG. 6 is a diagram illustrating an example of an image frame used in a method of operating a pixel circuit of an organic light emitting display device in accordance with example embodiments, and FIG. 7 is a diagram illustrating another example of an image frame used in a method of operating a pixel circuit of an organic light emitting display device in accordance with example embodiments.

Referring to FIGS. 1, 6, and 7, an organic light emitting display device including a pixel circuit 100 may drive the pixel circuit 100 with a digital driving method that adjusts an emission time duration to produce grayscale. For example, one image frame 400a or 400b may be divided into a plurality of sub-frames SF1, SF2, and SF3, and each sub-frame SF1, SF2, and SF3 may include a scan period (i.e., hatched portions in FIGS. 6 and 7) and an emission period. Each pixel circuit 100 may store a data signal during the scan period of each sub-frame SF1, SF2, and SF3, and may represent grayscale by selectively emitting light according to the stored data signal during the emission period of each sub-frame SF1, SF2, and SF3.

In some example embodiments, as illustrated in FIG. 6, pixel circuits 100 may sequentially emit light on a row basis. For example, after the pixel circuits 100 coupled to a first scan line are scanned, the pixel circuits 100 coupled to the first scan line may emit light while the pixel circuits 100 coupled to a second scan line are scanned. In some example embodiments, the image frame 400a may further include a hysteresis compensation sub-frame 410a. During the hysteresis compensation sub-frame 410a, a predetermined positive voltage (e.g., a voltage higher than a non-emission data voltage) may be applied through an emission control line EML, and thus, hysteresis of a driving transistor 140 may be prevented.

In other example embodiments, as illustrated in FIG. 7, pixel circuits 100 may substantially concurrently (or simultaneously) emit light. For example, after the pixel circuits 100 coupled to all scan lines are scanned, all the pixel circuits 100 may substantially concurrently emit light. This concurrent emission method may be usefully employed in an organic light emitting display device that displays a stereoscopic image. In some example embodiments, the image frame 400b may further include a hysteresis compensation sub-frame 410b.

FIG. 8 is a circuit diagram illustrating a pixel circuit of an organic light emitting display device in accordance with example embodiments.

Referring to FIG. 8, a pixel circuit 500 of an organic light emitting display device includes a switching transistor 510, a storage capacitor 520, an emission control transistor 530, a driving transistor 540, an organic light emitting diode 550, and a monitoring transistor 560. The pixel circuit 500 of FIG. 8 may have a similar configuration and a similar operation to a pixel circuit 100 of FIG. 1, except that the pixel circuit 500 may further include the monitoring transistor 560.

The monitoring transistor 560 may have a gate terminal coupled to a monitoring line ML, a first terminal (e.g., a source terminal) coupled to a data line DL, and a second terminal (e.g., a drain terminal) coupled to a first terminal of the driving transistor 540. The monitoring transistor 560 may be turned on in response to a monitoring signal applied through the monitoring line ML, and the turned-on monitoring transistor 560 may couple the data line DL to the first terminal of the driving transistor 540.

In some example embodiments, a first power supply voltage ELVDD may be applied to the data line DL, and the monitoring signal may be applied to the monitoring line ML. Accordingly, a current may flow through a path including the data line DL, the monitoring transistor 560, the driving transistor 540 and the organic light emitting diode 550. The current may be measured by a readout circuit coupled to one end of the data line DL, and a panel distribution compensating voltage and/or a pixel circuit distribution compensating voltage may be determined based on the measured current. In some example embodiments, the determination of the panel distribution compensating voltage and/or the pixel circuit distribution compensating voltage may be performed when the organic light emitting display device is manufactured. In other example embodiments, the determination of the panel distribution compensating voltage and/or the pixel circuit distribution compensating voltage may be periodically performed when the organic light emitting display device operates. In this case, the degradation of the driving transistor 540 and/or the organic light emitting diode 550 may be further compensated.

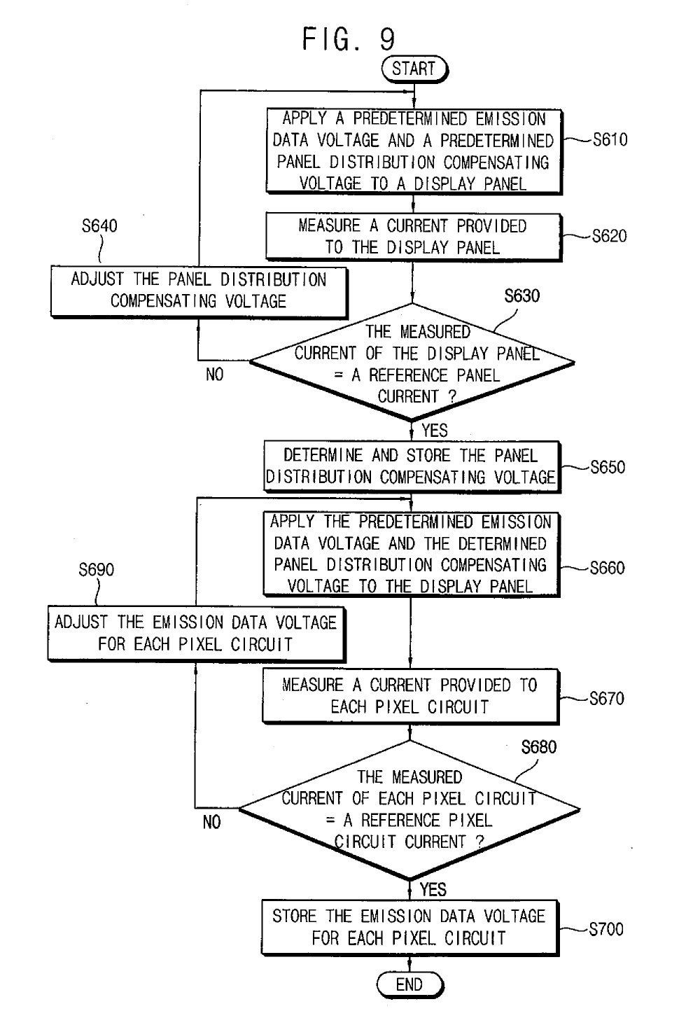

FIG. 9 is a flowchart illustrating a method of determining a panel distribution compensating voltage and a pixel circuit distribution compensating voltage in accordance with example embodiments.

Referring to FIGS. 8 and 9, a predetermined emission data voltage and a predetermined panel distribution compensating voltage may be applied to a display panel (S610). For example, the predetermined emission data voltage may be a default emission data voltage, and the predetermined panel distribution compensating voltage may be a default panel distribution compensating voltage.

A current provided to the display panel may be measured (S620). For example, organic light emitting diodes 550 may be provided with a current through data lines DL by applying a first power supply voltage ELVDD to the data lines DL and by turning on monitoring transistors 560 of all pixel circuits 100 included in the display panel. A readout circuit may measure the current provided to the monitoring transistors 560 of the pixel circuits 100.

The measured current of the display panel may be compared with a reference panel current (S630). If the measured current of the display panel is different from the reference panel current (S630: NO), the panel distribution compensating voltage may be adjusted (S640), the adjusted panel distribution compensating voltage may be applied to the display panel, and then the current of the display panel may be measured and compared again with the reference panel current (S610, S620 and S630). The adjustment of the panel distribution compensating voltage and the measurement of the current of the display panel may be repeatedly performed until the current of the display panel becomes substantially the same as the reference panel current.

If the measured current of the display panel is substantially the same as the reference panel current (S630: YES), the panel distribution compensating voltage causing the measured current of the display panel to become the reference panel current may be determined and stored as a final panel distribution compensating voltage (S650). When an organic light emitting display device operates, the stored panel distribution compensating voltage may be applied to the pixel circuits included in the display panel.

The stored panel distribution compensating voltage and the predetermined emission data voltage may be applied to the display panel (S660), a current provided to each pixel circuit may be measured (S670). For example, the readout circuit may sequentially measure currents provided to the pixel circuits on a row basis.

The measured current of each pixel circuit may be compared with a reference pixel circuit current (S680). If the measured current of each pixel circuit is different from the reference pixel circuit current (S680: NO), the emission data voltage for each pixel circuit may be adjusted (S690), the adjusted emission data voltage may be applied to the corresponding pixel circuit, and then the current of each pixel circuit may be measured and compared again with the reference pixel circuit current (S660, S670 and S680). The adjustment of the emission data voltage and the measurement of the current of each pixel circuit may be repeatedly performed until currents of all the pixel circuits become substantially the same as the reference pixel circuit current.

If the measured current of each pixel circuit is substantially the same as the reference pixel circuit current (S680: YES), the emission data voltage causing the measured current of the corresponding pixel circuit to become the reference pixel circuit current may be determined and stored as a final emission data voltage for the corresponding pixel circuit (S700). In some cases, different final emission data voltages may be stored for respective pixel circuits. In some example embodiments, the final emission data voltages may be stored. In other example embodiments, differences between the final emission data voltages and the default emission data voltage may be stored.

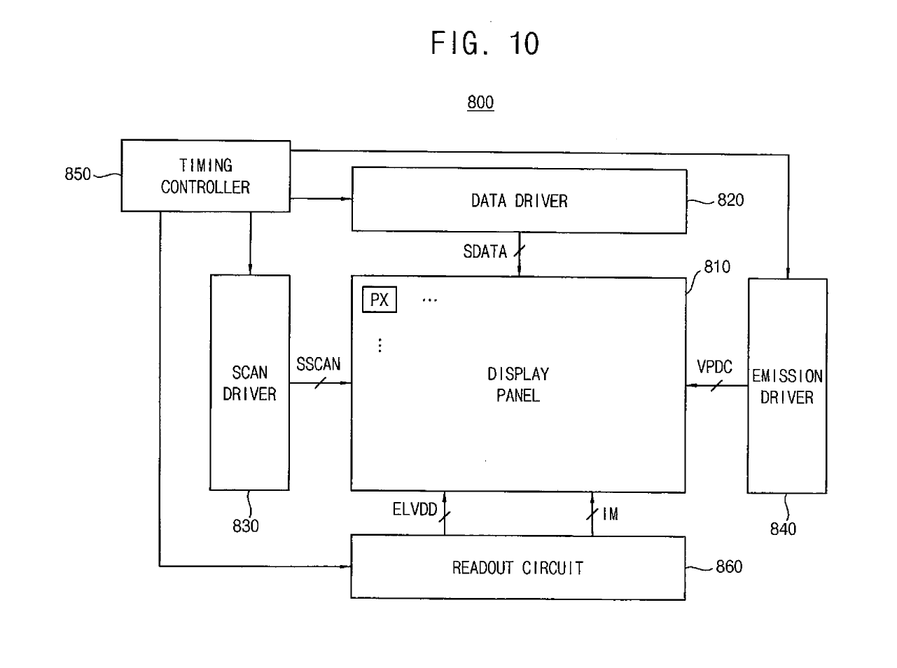

FIG. 10 is a block diagram illustrating an organic light emitting display device in accordance with example embodiments.

Referring to FIG. 10, an organic light emitting display device 800 includes a display panel 810, a data driver 820, a scan driver 830, an emission control driver 840, a timing controller 850, and a readout circuit 860.

The display panel 810 may be coupled to the data driver 820 through a plurality of data lines, may be coupled to the scan driver 830 through a plurality of scan lines, and may be coupled to the emission control driver 840 through a plurality of emission control lines. The display panel 810 may be further coupled to the readout circuit 860 through the plurality of data lines. In some example embodiments, the display panel 810 may be coupled to the data driver 820 at one end of the plurality of data lines, and may be coupled to the readout circuit 860 at the other end of the plurality of data lines. In other example embodiments, the data driver 820 and the readout circuit 860 may be integrally formed, and the display panel 810 may be coupled to the integrally formed data driver and data driver 820 and 860 at one end of the plurality of data lines. The display panel 810 may include a plurality of pixels PX located at crossing points of the plurality of data lines and the plurality of scan lines.

The data driver 820 may apply data signals SDATA (including an emission data voltage and a non-emission data voltage) to the display panel 810 through the plurality of data lines, and the scan driver 830 may apply scan signals SSCAN to the display panel 810 through the plurality of scan lines. The emission data voltage may include a pixel circuit distribution compensating voltage, and a threshold voltage deviation between the plurality of pixels PX of the display panel 810 may be compensated by the pixel circuit distribution compensating voltage.

The emission control driver may apply a panel distribution compensating voltage VPDC as an emission control signal to the display panel 810 through the plurality of emission control lines. A threshold voltage deviation between different display panels may be compensated by the panel distribution compensating voltage VPDC. Because the threshold voltage deviation between different display panels are compensated not by the data signal SDATA applied through the plurality of data lines, but instead, by the panel distribution compensating voltage VPDC applied through the plurality of emission control lines, the organic light emitting display device 800 according to example embodiments may reduce power consumption for charging and discharging the data lines by the data driver 820.

The readout circuit 860 may measure a current flowing through the plurality of pixels PX. For example, the readout circuit 860 may apply a high power supply voltage ELVDD to the plurality of pixels PX through the plurality of data lines, and may measure a current IM that is provided to the plurality of pixels PX through the plurality of data lines. In some example embodiments, the measurement of the current IM may be performed when the organic light emitting display device 800 is manufactured. In other example embodiments, the measurement of the current IM may be periodically performed when the organic light emitting display device 800 operates.

The timing controller 850 may control an operation of the organic light emitting display device 800. For example, the timing controller 850 may provide control signals to the data driver 820, the scan driver 830, the emission control driver 840, and the readout circuit 860. In some example embodiments, the timing controller 850 may determine and store the pixel circuit distribution compensating voltage and the panel distribution compensating voltage VPDC based on the current IM measured by the readout circuit 860. The timing controller 850 may control the data driver 820 based on the stored pixel circuit distribution compensating voltage, and may control the emission control driver 840 based on the stored panel distribution compensating voltage VPDC.

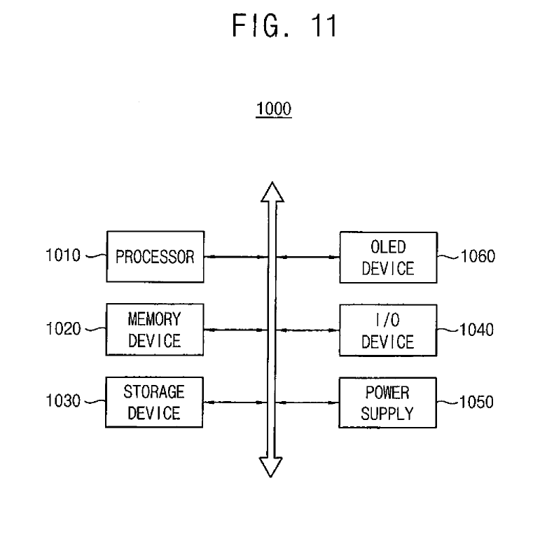

FIG. 11 is a block diagram illustrating an electronic system including an organic light emitting display device in accordance with example embodiments.

Referring to FIG. 11, an electronic system 1000 includes a processor 1010, a memory device 1020, a storage device 1030, an input/output (I/O) device 1040, a power supply 1050, and an organic light emitting display device 1060. The electronic system 1000 may further include a plurality of ports for communicating with a video card, a sound card, a memory card, a universal serial bus (USB) device, other electronic systems, etc.

The processor 1010 may perform various computing functions or tasks. The processor 1010 may be for example, a microprocessor, a central processing unit (CPU), etc. The processor 1010 may be connected to other components via an address bus, a control bus, a data bus, etc. Further, the processor 1010 may be coupled to an extended bus, such as a peripheral component interconnection (PCI) bus.

The memory device 1020 may store data for operations of the electronic system 1000. For example, the memory device 1020 may include at least one non-volatile memory device, such as an erasable programmable read-only memory (EPROM) device, an electrically erasable programmable read-only memory (EEPROM) device, a flash memory device, a phase change random access memory (PRAM) device, a resistance random access memory (RRAM) device, a nano floating gate memory (NFGM) device, a polymer random access memory (PoRAM) device, a magnetic random access memory (MRAM) device, a ferroelectric random access memory (FRAM) device, etc, and/or at least one volatile memory device, such as a dynamic random access memory (DRAM) device, a static random access memory (SRAM) device, a mobile dynamic random access memory (mobile DRAM) device, etc.

The storage device 1030 may be, for example, a solid state drive (SSD) device, a hard disk drive (HDD) device, a CD-ROM device, etc. The I/O device 1040 may be, for example, an input device such as a keyboard, a keypad, a mouse, a touch screen, etc, and/or an output device such as a printer, a speaker, etc. The power supply 1050 may supply power for operations of the electronic system 1000. The organic light emitting display device 1060 may communicate with other components via the buses or other communication links.

The organic light emitting display device 1060 may compensate a threshold voltage deviation between display panels by applying a panel distribution compensating voltage through an emission control line, thereby reducing power consumption for charging and discharging a data line. In some example embodiments, the organic light emitting display device 1060 may use a negative voltage as an emission data voltage, and may use a positive voltage as a non-emission data voltage, thereby further reducing the power consumption for charging and discharging the data line.

The present embodiments may be applied to any electronic system 1000 having the organic light emitting display device 1060. For example, the present embodiments may be applied to the electronic system 1000, such as a television, a computer monitor, a laptop, a digital camera, a cellular phone, a smart phone, a personal digital assistant (PDA), a portable multimedia player (PMP), a MP3 player, a navigation system, a video phone, etc.

The foregoing is illustrative of example embodiments, and is not to be construed as limiting thereof. Although a few example embodiments have been described, those skilled in the art will readily appreciate that many modifications are possible in the example embodiments without materially departing from the spirit and scope of the present invention. Accordingly, all such modifications are intended to be included within the scope of present invention as defined by the claims. Therefore, it is to be understood that the foregoing is illustrative of example embodiments and is not to be construed as limited to the specific embodiments disclosed, and that modifications to the disclosed example embodiments, as well as other example embodiments, are intended to be included within the scope of the appended claims. The present invention is defined by the following claims, with equivalents of the claims to be included therein.

What is claimed is:

1. A pixel circuit of an organic light emitting display device, comprising:
a storage capacitor comprising a first electrode and a second electrode;
a switching transistor comprising a gate terminal coupled to a scan line, a first terminal coupled to a data line, and a second terminal coupled to the first electrode of the storage capacitor;
an emission control transistor comprising a gate terminal coupled to an emission control line, a first terminal coupled to a first power supply voltage, and a second terminal;
a driving transistor comprising a gate terminal coupled to the first electrode of the storage capacitor, a first terminal coupled to the second terminal of the emission control transistor, and a second terminal; and
an organic light emitting diode comprising an anode electrode coupled to the second terminal of the driving transistor, and a cathode electrode coupled to a second power supply voltage,
wherein the emission control line is coupled to the gate terminal of the emission control transistor and is coupled to the second electrode of the storage capacitor, and
wherein a panel distribution compensating voltage is configured to be applied to the second electrode of the storage capacitor through the emission control line.

2. The pixel circuit of claim 1, wherein the switching transistor is configured to apply one of an emission data voltage or a non-emission data voltage received from the data line to the first electrode of the storage capacitor in response to a scan signal received from the scan line.

3. The pixel circuit of claim 2, wherein the emission data voltage and the non-emission data voltage have opposite electrical polarities from each other.

4. The pixel circuit of claim 3, wherein the emission data voltage is a negative voltage, and the non-emission data voltage is a positive voltage.

5. The pixel circuit of claim 2, wherein the emission data voltage comprises a pixel circuit distribution compensating voltage.

6. The pixel circuit of claim 5,
wherein a threshold voltage deviation between a plurality of display panels is configured to be compensated by the panel distribution compensating voltage applied through the emission control line, and
wherein a threshold voltage deviation between a plurality of pixel circuits in a single display panel is configured to be compensated by the pixel circuit distribution compensating voltage applied through the data line.

7. The pixel circuit of claim 1, wherein the emission control transistor is configured to receive, as an emission control signal, the panel distribution compensating voltage from the emission control line.

8. The pixel circuit of claim 7, wherein the emission control transistor is configured to couple the first power supply voltage to the first terminal of the driving transistor in response to the panel distribution compensating voltage received from the emission control line.

9. The pixel circuit of claim 1, further comprising:
a monitoring transistor comprising a gate terminal coupled to a monitoring line, a first terminal coupled to the data line, and a second terminal coupled to the first terminal of the driving transistor.

10. The pixel circuit of claim 9, wherein the monitoring transistor is configured to couple the data line to the first terminal of the driving transistor in response to a monitoring signal received from the monitoring line.

11. The pixel circuit of claim 9, wherein the panel distribution compensating voltage is determined by measuring a current flowing through a path comprising the data line, the monitoring transistor, the driving transistor, and the organic light emitting diode.

12. A pixel circuit of an organic light emitting display device, comprising:
a storage capacitor comprising a first electrode and a second electrode;
a switching transistor configured to apply one of an emission data voltage or a non-emission data voltage received from a data line to the first electrode of the storage capacitor in response to a scan signal;
an emission control transistor configured to be turned on in response to a panel distribution compensating voltage applied as an emission control signal through an emission control line; a driving transistor configured to generate a driving current based on a voltage of the first electrode of the storage capacitor; and
an organic light emitting diode configured to emit light in response to the driving current generated by the driving transistor,
wherein the emission control line is coupled to the emission control transistor and is coupled to the second electrode of the storage capacitor, and
wherein the panel distribution compensating voltage is applied to the second electrode of the storage capacitor through the emission control line.

13. The pixel circuit of claim 12, wherein the emission data voltage and the non-emission data voltage have opposite electrical polarities from each other.

14. The pixel circuit of claim 13, wherein the emission data voltage is a negative voltage, and the non-emission data voltage is a positive voltage.

15. The pixel circuit of claim 12, wherein the emission data voltage comprises a pixel circuit distribution compensating voltage.

16. The pixel circuit of claim 15,
wherein a threshold voltage deviation between a plurality of display panels is configured to be compensated by the panel distribution compensating voltage applied through the emission control line, and
wherein a threshold voltage deviation between a plurality of pixel circuits in a single display panel is configured to be compensated by the pixel circuit distribution compensating voltage applied through the data line.

17. The pixel circuit of claim 12, further comprising:
a monitoring transistor configured to couple the data line to the driving transistor in response to a monitoring signal received from a monitoring line.

18. The pixel circuit of claim 17, wherein the panel distribution compensating voltage is determined by measuring a current flowing through a path comprising the data line, the monitoring transistor, the driving transistor and the organic light emitting diode.

19. A method of operating a pixel circuit of an organic light emitting display device, the method comprising:
applying one of an emission data voltage or a non-emission data voltage to a first electrode of a storage capacitor through a data line;
applying a panel distribution compensating voltage as an emission control signal to an emission control transistor and to a second electrode of the storage capacitor through an emission control line; and
driving an organic light emitting diode based on a voltage of the first electrode of the storage capacitor.

20. The method of claim 19, wherein the emission data voltage is a negative voltage, and the non-emission data voltage is a positive voltage.

21. The method of claim 20, wherein the emission data voltage comprises a pixel circuit distribution compensating voltage.

22. The method of claim 21,
wherein a threshold voltage deviation between a plurality of display panels is compensated by the panel distribution compensating voltage applied through the emission control line, and
wherein a threshold voltage deviation between a plurality of pixel circuits in a single display panel is compensated by the pixel circuit distribution compensating voltage applied through the data line.
